(19) United States
(12) Patent Application Publication
(10) Pub. No.: US 2024/0023182 A1
(43) Pub. Date: Jan. 18, 2024

(54) HANDLING THE UNKNOWN RRC ESTABLISHMENT CAUSE VALUE IN NR

(71) Applicant: Telefonaktiebolaget LM Ericsson (publ), Stockolm (SE)

(72) Inventors: Nianshan Shi, Järfälla (SE); Markus Drevö, Linköping (SE); Fredrik Hultin, Vikingstad (SE); Klas A Johansson, Norrköping (SE)

(21) Appl. No.: 18/031,665

(22) PCT Filed: Oct. 13, 2021
(86) PCT No.: PCT/IB2021/059417

§ 371 Date: Apr. 13, 2023

Related U.S. Application Data
(60) Provisional application No. 63/092,258, filed on Oct. 15, 2020.

(51) Int. Cl. H04W 76/19; H04W 72/21

(52) U.S. Cl. CPC H04W 76/19; H04W 72/21

(57) ABSTRACT

Systems and methods are disclosed herein for handling an unknown Radio Resource Control (RRC) establishment cause value in a cellular communications system. In one embodiment, a method performed in a cellular communications system comprises, at a Radio Access Network (RAN) node in a RAN of the cellular communications system, receiving a RRC message from a User Equipment (UE) comprising an unknown establishment cause value and sending a message to a core network node, the message comprising an indication that the unknown cause value is included in the RRC message received from the UE. The method further comprises, at the core network node in a core network of the cellular communications system, receiving the message from the RAN node. In this manner, handling of an unknown RRC cause value over the interface between the RAN node and the core network node is enabled.

### RELATED APPLICATIONS

This application claims the benefit of provisional patent application Ser. No. 63/092,258, filed Oct. 15, 2020, the disclosure of which is hereby incorporated herein by reference in its entirety.

### TECHNICAL FIELD

The present disclosure relates to a cellular communications system, such as a Third Generation Partnership Project (3GPP) Fifth Generation System (5GS), in which an unknown Radio Resource Control (RRC) establishment cause may be received by the network in an RRC message from a User Equipment (UE).

### BACKGROUND

FIG. 1 shows the message flow when a Radio Resource Control (RRC) connection is setup in Third Generation Partnership Project (3GPP) New Radio (NR). As illustrated in FIG. 1, a User Equipment (UE) and Next Generation (NG) Radio Access Network (RAN) node, i.e., a NG-RAN node, interact to perform a RRC connection establishment procedure in which the UE sends an RRCSetupRequest message to the NG-RAN node, the NG-RAN node responds to the UE with an RRCSetup message, and the UE then sends an RRCSetupComplete message to the NG-RAN node. Details regarding the RRC connection establishment procedure can be found in 3GPP Technical Specification (TS) 38.331 V16.2.0, Section 5.3.3. The NG-RAN node sends an Initial UE Message to the Access and Mobility Function (AMF) in the 5G Core (5GC) over the NGAP interface. Details regarding the Initial UE Message can be found in 3GPP TS 38.413 V.3.0, Section 8.6.1.

In some cases, the Initial UE message is already sent after the RRCSetupRequest (e.g., in an early data transmission in Narrowband Internet of Things (NB-IoT)). In the RRCSetupRequest over the RRC interface, the UE provides an “establishmentCause” to the NG-RAN node. The NG-RAN node needs to send the establishment cause received over RRC from the UE to Access and Mobility Function (AMF) in the 5G Core (5GC) over the NGAP interface. There are different measurements related to the RRC establishment cause. Different Non-Access Stratum (NAS) procedures are mapped to the establishment causes.

### SUMMARY

Systems and methods are disclosed herein for handling an unknown Radio Resource Control (RRC) establishment cause value in a cellular communications system. In one embodiment, a method performed in a cellular communications system comprises, at a Radio Access Network (RAN) node in a RAN of the cellular communications system, receiving a RRC message from a User Equipment (UE) comprising an unknown establishment cause value and sending a message to a core network node, the message comprising an indication that the unknown cause value is included in the RRC message received from the UE. The method further comprises, at the core network node in a core network of the cellular communications system, receiving the message from the RAN node. In this manner, handling of an unknown RRC cause value over the interface between the RAN node and the core network node is enabled.

In one embodiment, the method further comprises, at the core network node, performing one or more actions responsive to the indication that the unknown cause value is included in the RRC message received by the RAN node from the UE.

In one embodiment, the message sent from the RAN node to the core network node is a NGAP message.

Embodiments of a method performed by a network node for a cellular communications system are also disclosed. In one embodiment, the method performed by the network node comprises receiving an RRC message from a UE, the message comprising an unknown cause value. The method further comprises sending a message to a core network node, the message comprising an indication that the unknown cause value is included in the RRC message received from the UE.

In one embodiment, the message sent to the core network node is a NGAP message.

In one embodiment, the RRC message is an RRC message for establishment of an RRC connection. In one embodiment, the unknown cause value is comprised in an EstablishmentCause Information Element (IE) comprised in the RRC message for establishment of the RRC connection. In another embodiment, the unknown cause value is comprised in an EstablishmentCause-NB IE comprised in the RRC message for establishment of the RRC connection.

In another embodiment, the RRC message is an RRC message for resuming an RRC connection. In one embodiment, the unknown cause value is comprised in a ResumeCause IE comprised in the RRC message for resuming the RRC connection.

In one embodiment, the message sent to the core network node is a NGAP message, and the indication that the unknown cause value is included in the RRC message received from the UE is an existing notAvailable code point in a NGAP RRC Establishment Cause IE comprised in the NGAP message. In another embodiment, the message sent to the core network node is a NGAP message, and the indication that the unknown cause value is included in the RRC message received from the UE is a new code point in a NGAP RRC Establishment Cause IE comprised in the NGAP message.

In one embodiment, the message sent to the core network node is a NGAP message, and the NGAP message is an NGAP Initial UE Message.

In one embodiment, the network node is a Next Generation RAN (NG-RAN) node.

In one embodiment, the core network node is an Access and Mobility Management Function (AMF).

Corresponding embodiments of a network node for a cellular communications system are also disclosed. In one embodiment, the network node is adapted to receive an RRC message from a UE comprising an unknown cause value and send a message to a core network node, the message comprising an indication that the unknown cause value is included in the RRC message received from the UE.

In another embodiment, a network node for a cellular communications system comprises processing circuitry configured to cause the network node to receive an RRC message from a UE comprising an unknown cause value and send a message to a core network node, the message comprising an indication that the unknown cause value is included in the RRC message received from the UE.

Embodiments of a method performed by a core network node for a cellular communications system are also disclosed. In one embodiment, the method performed by the core network node comprises receiving a message from a RAN node in a RAN of the cellular communications system, the message comprising an indication that an unknown cause value is included in an RRC message received by the RAN node from a UE.

In one embodiment, the message received from the RAN node is a NGAP message.

In one embodiment, the method further comprises performing one or more actions responsive to the indication that the unknown cause value is included in the RRC message received by the RAN node from the UE.

In one embodiment, the RRC message is an RRC message for establishment of an RRC connection. In one embodiment, the unknown cause value is comprised in an EstablishmentCause IE comprised in the RRC message for establishment of the RRC connection. In another embodiment, the unknown cause value is comprised in an EstablishmentCause-NB IE comprised in the RRC message for establishment of the RRC connection.

In another embodiment, the RRC message is an RRC message for resuming an RRC connection. In one embodiment, the unknown cause value is comprised in a ResumeCause IE comprised in the RRC message for resuming the RRC connection.

In one embodiment, the message received from the RAN node is a NGAP message, and the indication that the unknown cause value is included in the RRC message received by the RAN node from the UE is an existing notAvailable code point in a NGAP RRC Establishment Cause IE comprised in the NGAP message. In another embodiment, the message received from the RAN node is a NGAP message, and the indication that the unknown cause value is included in the RRC message received by the RAN node from the UE is a new code point in a NGAP RRC Establishment Cause IE comprised in the NGAP message.

In one embodiment, the message received from the RAN node is a NGAP message, and the NGAP message is an NGAP Initial UE Message.

In one embodiment, the RAN node is a NG-RAN node.

In one embodiment, the core network node is an AMF.

Corresponding embodiments of a core network node are also disclosed. In one embodiment, the core network node is adapted to receive a message from a RAN node in a RAN of the cellular communications system, the message comprising an indication that an unknown cause value is included in an RRC message received by the RAN node from a UE.

In another embodiment, a core network node for a cellular communications system comprises processing circuitry configured to cause the core network node to receive a message from a RAN node in a RAN of the cellular communications system, the message comprising an indication that an unknown cause value is included in an RRC message received by the RAN node from a UE.

Embodiments for handling an establishment cause value received at a RAN node from a UE in an RRC message, where the establishment cause is known to the RAN node but unknown to a core network node to which a message is to be sent are also disclosed. In one embodiment, a method performed in a cellular communications system comprises, at a RAN node in a RAN of the cellular communications system, receiving an RRC message from a UE comprising an establishment cause value that is known to the RAN node but is unknown to a core network node to which a message is to be sent and sending a message to the core network node, the message comprising an indication that the establishment cause value included in the RRC message received from the UE is an establishment cause value that is unknown to the core network node. The method further comprises, at the core network node in a core network of the cellular communications system, receiving the message from the RAN node.

In one embodiment, the establishment cause value included in the RRC message received from the UE does not have an explicitly defined mapping to a cause value for the message to be sent to the core network node.

In one embodiment, the indication is an existing codepoint. In one embodiment, the existing codepoint is a “not available” value.

In one embodiment, the indication is a new codepoint for the cause value included in the message sent to the core network node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows the message flow when a Radio Resource Control (RRC) connection is setup in Third Generation Partnership Project (3GPP) New Radio (NR);

FIG. 2 illustrates one example of a cellular communications system in which embodiments of the present disclosure may be implemented;

FIGS. 3 and 4 illustrates example architecture reference diagrams for embodiments in which the cellular communications system of FIG. 2 is a 3GPP Fifth Generation System (5GS);

FIG. 5 illustrates the operation of a User Equipment (UE), a Radio Access Network (RAN) node, and an Access and Mobility Management Function (AMF) in accordance with one example embodiment of the present disclosure;

FIGS. 6, 7, and 8 are schematic block diagrams of example embodiments of a network node.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). According to the 3GPP Radio Resource Control (RRC) specification TS 38.331, a Next Generation Radio Access Network (NG-RAN) node (i.e., gNB or ng-eNB) is not expected to reject an RRCSetupRequest due to unknown cause value being used by the UE. Specifically, TS 38.331 states, in pertinent part:
establishmentCause
Provides the establishment cause for the RRCSetupRequest in accordance with the information received from upper layers. gNB is not expected to reject an RRCSetupRequest due to unknown cause value being used by the UE.
   However, when the UE sends the unknown cause over RRC during establishment, how to handle it is unspecified. This case could happen, for example, if the UE uses a newer version of RRC specification (TS 38.331) where a new RRC EstablishmentCause has been added but the NG-RAN node is using an older version of the RRC specification. Also, the NGAP specification, which is 3GPP TS 38.413, does not provide any cause value which is mapped to indicate that the RRC Establishment case is “unknown” to the AMF.

When the UE provides an unknown establishment cause over RRC and an unknown cause is not specified in, e.g., the NGAP Initial UE message procedure, the action that the NG-RAN node/AMF may take depends on the implementation. For example, the NG-RAN node/AMF may:
1. Use a random cause value as the RRC Establishment cause in the Initial UE Message. This would lead to inaccurate Key Performance Indicator (KPI) and bring other negative consequences.
2. Ignore the RRC establishment request by the UE.
3. Reject RRC establishment request by the UE.

Certain aspects of the present disclosure and their embodiments may provide solutions to the aforementioned or other challenges. The present disclosure provides solutions to define an unknown RRC establishment cause value over the NGAP.

Certain embodiments may provide one or more of the following technical advantage(s). Embodiments of the present disclosure enable handling of an unknown RRC cause value over the NGAP interface. As such, ambiguity that currently exists in the 3GPP specifications is clarified.

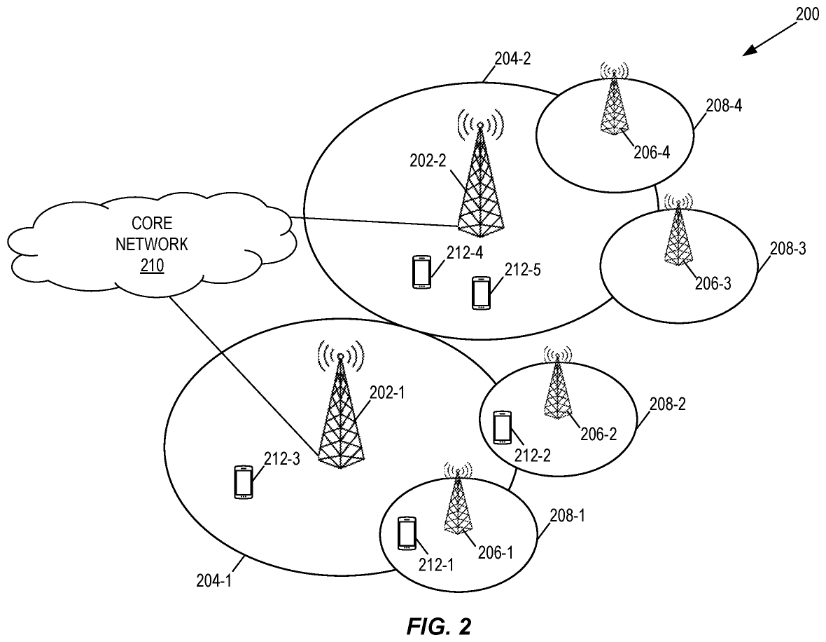

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC); however, solutions disclosed herein are not limited thereto. In this example, the RAN includes RAN nodes 202-1 and 202-2, which in the 5GS include NG-RAN nodes, which include NR base stations (gNBs) and optionally next generation eNBs (ng-eNBs), controlling corresponding (macro) cells 204-1 and 204-2. The RAN nodes 202-1 and 202-2 are generally referred to herein collectively as RAN nodes 202 and individually as RAN node 202. Likewise, the (macro) cells 204-1 and 204-2 are generally referred to herein collectively as (macro) cells 204 and individually as (macro) cell 204. The RAN may also include a number of low power RAN nodes 206-1 through 206-4 controlling corresponding small cells 208-1 through 208-4. The low power RAN nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the RAN nodes 202. The low power RAN nodes 206-1 through 206-4 are generally referred to herein collectively as low power RAN nodes 206 and individually as low power RAN node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The RAN nodes 202 (and optionally the low power RAN nodes 206) are connected to the core network 210.

The RAN nodes 202 and the low power RAN nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs and as such are oftentimes referred to herein as UEs 212, but the present disclosure is not limited thereto.

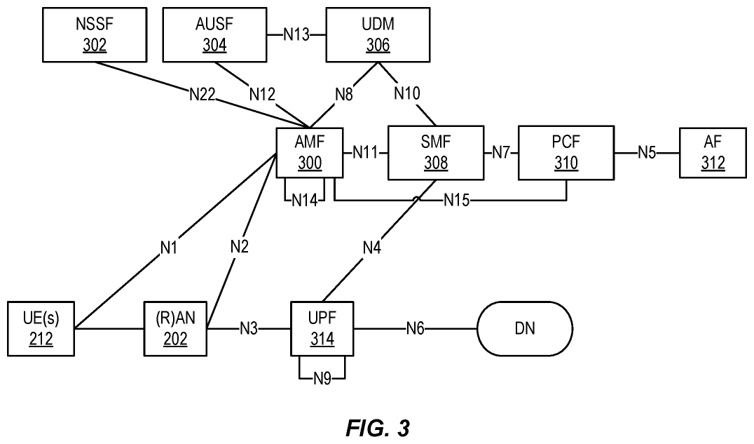

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side the 5G network architecture shown in FIG. 3 comprises a plurality of UEs 212 connected to either a RAN 202 or an Access Network (AN) as well as an AMF 300. Typically, the R(AN) 202 comprises NG-RAN nodes, e.g. such as gNBs or ng-eNBs or similar. Seen from the core network side, the 5GC NFs shown in FIG. 3 include a NSSF 302, an AUSF 304, a UDM 306, the AMF 300, a SMF 308, a PCF 310, and an Application Function (AF) 312.

Reference point representations of the 5G network architecture are used to develop detailed call flows in the normative standardization. The N1 reference point is defined to carry signaling between the UE 212 and AMF 300. The reference points for connecting between the AN 202 and AMF 300 and between the AN 202 and UPF 314 are defined as N2 and N3, respectively. There is a reference point, N11, between the AMF 300 and SMF 308, which implies that the SMF 308 is at least partly controlled by the AMF 300. N4 is used by the SMF 308 and UPF 314 so that the UPF 314 can be set using the control signal generated by the SMF 308, and the UPF 314 can report its state to the SMF 308. N9 is the reference point for the connection between different UPFs 314, and N14 is the reference point connecting between different AMFs 300, respectively. N15 and N7 are defined since the PCF 310 applies policy to the AMF 300 and SMF 308, respectively. N12 is required for the AMF 300 to perform authentication of the UE 212. N8 and N10 are defined because the subscription data of the UE 212 is required for the AMF 300 and SMF 308.

The 5GC network aims at separating UP and CP. The UP carries user traffic while the CP carries signaling in the network. In FIG. 3, the UPF 314 is in the UP and all other NFs, i.e., the AMF 300, SMF 308, PCF 310, AF 312, NSSF 302, AUSF 304, and UDM 306, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 300 and SMF 308 are independent functions in the CP. Separated AMF 300 and SMF 308 allow independent evolution and scaling. Other CP functions like the PCF 310 and AUSF 304 can be separated as shown in FIG. 3. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

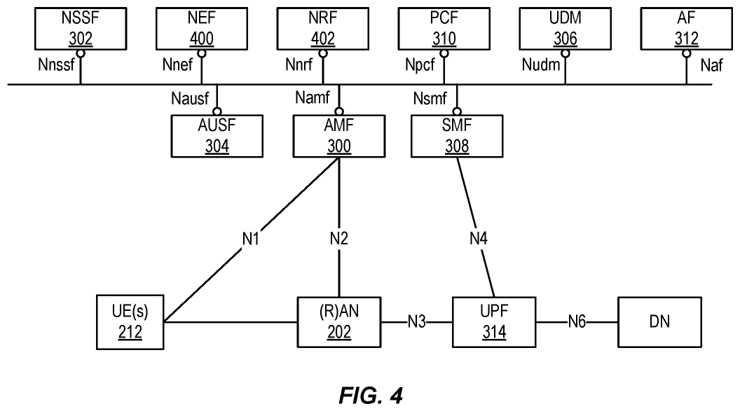

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service based interfaces are indicated by the letter “N” followed by the name of the NF, e.g. Namf for the service based interface of the AMF 300 and Nsmf for the service based interface of the SMF 308, etc. The NEF 400 and the NRF 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 300 provides UE-based authentication, authorization, mobility management, etc. A UE 212 even using multiple access technologies is basically connected to a single AMF 300 because the AMF 300 is independent of the access technologies. The SMF 308 is responsible for session management and allocates Internet Protocol (IP) addresses to UEs. It also selects and controls the UPF 314 for data transfer. If a UE 212 has multiple sessions, different SMFs 308 may be allocated to each session to manage them individually and possibly provide different functionalities per session. The AF 312 provides information on the packet flow to the PCF 310 responsible for policy control in order to support QoS. Based on the information, the PCF 310 determines policies about mobility and session management to make the AMF 300 and SMF 308 operate properly. The AUSF 304 supports authentication function for UEs or similar and thus stores data for authentication of UEs or similar while the UDM 306 stores subscription data of the UE 212. The Data Network (DN), not part of the network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Embodiments of the present disclosure will now be described. In a first solution, an existing code point, e.g., the “notAvailable” code point, in the NGAP RRC Establishment Cause Information Element (IE) is used to indicate when the UE 212 sends unknown cause value in the EstablishmentCause during RRC connection setup. One example embodiment of the first solution is illustrated below as an update to 3GPP TS 38.413 with additions being underlined and bolded:

9.3.1.111 RRC Establishment Cause
This IE indicates the reason for RRC Connection Establishment as received from the UE in the EstablishmentCause
defined in TS 38.331 [18] and TS 36.331 [21], or the reason for RRC Connection Resume as received from the UE in the
ResumeCause defined in TS 38.331 [18] and TS 36.331 [21], or the reason for RRC Connection Establishment as received
from the UE in the EstablishmentCause-NB defined in TS 36.331 [21].

| | | | IE type and | |
|---|---|---|---|---|
| IE/Group Name | Presence | Range | reference | Semantics description |
| RRC Establishment | M | | ENUMERATED | The notAvailable value is |
| Cause | | | (emergency, | used in case the UE is re- |
| | | | highPriorityAccess, | establishing an RRC |
| | | | mt-Access, | connection but there is |
| | | | mo-Signalling, | fallback to RRC |
| | | | mo-Data, | connection establishment |
| | | | mo-VoiceCall, | as described in [18], or |
| | | | mo-VideoCall, | the ResumceCause |
| | | | mo-SMS, | received from the UE |
| | | | mps- | does not map to any other |
| | | | PriorityAccess, | value of the RRC |
| | | | mcs- | Establishment Cause IE, |
| | | | PriorityAccess, | or the |
| | | | . . . , | EstablishmentCause |
| | | | notAvailable, mo- | received from the UE is |
| | | | ExceptionData) | unknown. |

In a second solution, a new code point “Unknown” is introduced in the NGAP RRC Establishment Cause IE. The benefit in the solution is the KPI and the handling for the existing code point (e.g., the “notAvailable” codepoint) is not impacted. The drawback is that the ASN.1 code is impacted. But the change is backwards compatible. One example embodiment of the second solution is illustrated below as an update to 3GPP TS 38.413 with additions being underlined and bolded:

9.3.1.111 RRC Establishment Cause
This IE indicates the reason for RRC Connection Establishment as received from the UE in the EstablishmentCause
defined in TS 38.331 [18] and TS 36.331 [21], or the reason for RRC Connection Resume as received from the UE in the
ResumeCause defined in TS 38.331 [18] and TS 36.331 [21], or the reason for RRC Connection Establishment as received
from the UE in the EstablishmentCause-NB defined in TS 36.331 [21].

| | | | IE type and | |
|---|---|---|---|---|
| IE/Group Name | Presence | Range | reference | Semantics description |
| RRC Establishment | M | | ENUMERATED | The notAvailable value is |
| Cause | | | (emergency, | used in case the UE is re- |
| | | | highPriorityAccess, | establishing an RRC |
| | | | mt-Access, | connection but there is |
| | | | mo-Signalling, | fallback to RRC |
| | | | mo-Data, | connection establishment |
| | | | mo-VoiceCall, | as described in [18], or |
| | | | mo-VideoCall, | the ResumceCause |
| | | | mo-SMS, | received from the UE |
| | | | mps- | does not map to any other |
| | | | PriorityAccess, | value of the RRC |
| | | | mcs- | Establishment Cause IE, |
| | | | PriorityAccess, | The unknown value is |
| | | | . . . , | used in case the UE |
| | | | notAvailable, mo- | sends unknown cause |
| | | | ExceptionData, | value over in |
| | | | unknown) | EstablishmentCause |

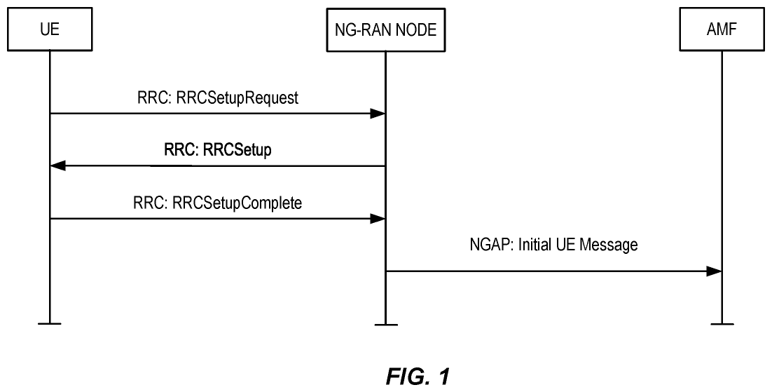

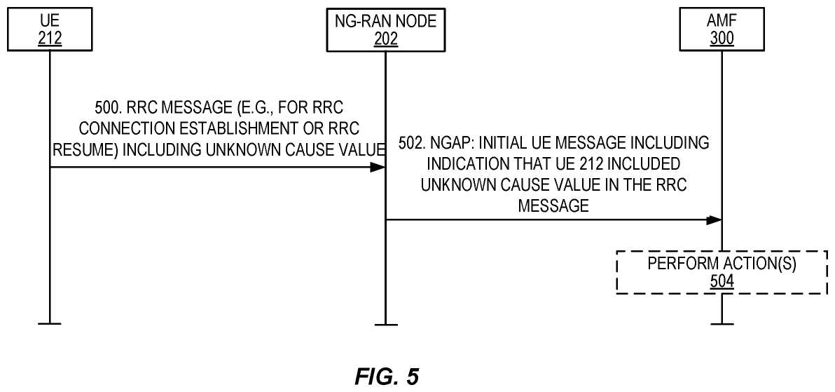

FIG. 5 illustrates the operation of the UE 212, the RAN node 202 (which in this example is an NG-RAN node and as such is referred to as a NG-RAN node 202), and the AMF 300 in accordance with one example embodiment of the solutions disclosed herein. Optional steps are represented by dashed lines/boxes. As illustrated, the UE 212 sends an RRC message to the NG-RAN node 202 (step 500). The RRC message includes an unknown cause value. The RRC message may be an RRCSetupRequest message that includes the unknown cause value in the EstablishmentCause IE, a RRC Connection Resume message that includes the unknown cause value in the ResumeCause IE, or RRC connection establishment request that includes the unknown cause value in the EstablishmentCause-NB IE. The RRC connection establishment or resume procedure may continue in the normal manner (not shown, but see FIG. 1 as an example). Responsive to or in association with the RRC message of step 500, the NG-RAN node 202 sends an Initial UE Message to the AMF 300 that includes an indication that the UE 212 has sent the unknown cause value in the RRC message of step 500 (step 502). The indication included in the Initial UE Message is either:
an existing codepoint (e.g., the “notAvailable” codepoint) in the NGAP RRC Establishment Cause IE contained in the Initial UE Message (first solution), or
a new codepoint “Unknown” (or some other named codepoint having the same purpose) in the NGAP RRC Establishment Cause IE to indicate that the UE 212 has sent the unknown cause value in the RRC message.
   The AMF 300 may perform one or more actions based on the indication included in the Initial UE Message (step 504). For example, if the core network is overloaded, the AMF 300 requests rejection on certain causes such as, e.g., “notAvailable” or “unknown”. Or, it may have some KPI related.

It should be noted that while the embodiments described above focus on embodiments in which the cause value (e.g., the Establishment Cause) in the RRC message received at the NG-RAN node 202 from the UE 212 is unknown to the NG-RAN node 202, the embodiments can also be used when the Establishment Cause in the RRC message received at the NG-RAN node 202 from the UE 212 is known to the NG-RAN node 202 but there is no mapping to an appropriate cause in the NGAP RRC Establishment Cause IE. In this case, the NG-RAN node 202 may map the known EstablishmentCause in the RRC message received from the UE 212 to either an existing codepoint (e.g., the “notAvailable” codepoint) in the NGAP RRC Establishment Cause IE contained in the Initial UE Message or a new codepoint “Unknown” (or some other named codepoint having the same purpose) in the NGAP RRC Establishment Cause IE to indicate that the UE 212 has sent the unknown cause value in the RRC message.

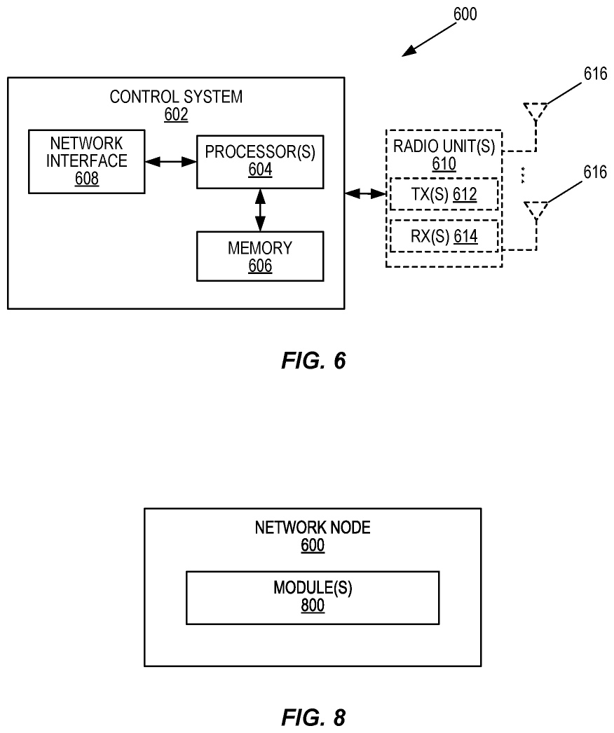

FIG. 6 is a schematic block diagram of a network node 600 according to some embodiments of the present disclosure. Optional features are represented by dashed boxes. The network node 600 may be, for example, the network node may be the RAN node 202 or 206, a network node that implements all or part of the functionality of the RAN node 202 or 206, or a network node that implements the functionality of the AMF 300 described herein. As illustrated, the network node 600 includes a control system 602 that includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. In addition, if the network node 600 is a RAN node, the network node 600 may include one or more radio units 610 that each includes one or more transmitters 612 and one or more receivers 614 coupled to one or more antennas 616. The radio units 610 may be referred to or be part of radio interface circuitry. In some embodiments, the radio unit(s) 610 is external to the control system 602 and connected to the control system 602 via, e.g., a wired connection (e.g., an optical cable). However, in some other embodiments, the radio unit(s) 610 and potentially the antenna(s) 616 are integrated together with the control system 602. The one or more processors 604 operate to provide one or more functions of the network node 600 as described herein (e.g., one or more functions of the RAN node 202, NG-RAN node 202, or AMF 300, as described herein). In some embodiments, the function(s) are implemented in software that is stored, e.g., in the memory 606 and executed by the one or more processors 604.

FIG. 7 is a schematic block diagram that illustrates a virtualized embodiment of the network node 600 according to some embodiments of the present disclosure. Again, optional features are represented by dashed boxes. As used herein, a “virtualized” network node is an implementation of the network node 600 in which at least a portion of the functionality of the network node 600 is implemented as a virtual component(s) (e.g., via a virtual machine(s) executing on a physical processing node(s) in a network(s)). As illustrated, in this example, the network node 600 includes one or more processing nodes 700 coupled to or included as part of a network(s) 702. Each processing node 700 includes one or more processors 704 (e.g., CPUs, ASICs, FPGAs, and/or the like), memory 706, and a network interface 708. If the network node 600 is a RAN node, the network node 600 may include the control system 602 and/or the one or more radio units 610, as described above. If present, the control system 602 or the radio unit(s) are connected to the processing node(s) 700 via the network 702.

In this example, functions 710 of the network node 600 described herein (e.g., one or more functions of the RAN node 202, NG-RAN node 202, or AMF 300, as described herein) are implemented at the one or more processing nodes 700 or distributed across the one or more processing nodes 700 and the control system 602 and/or the radio unit(s) 610 in any desired manner. In some particular embodiments, some or all of the functions 710 of the network node 600 described herein are implemented as virtual components executed by one or more virtual machines implemented in a virtual environment(s) hosted by the processing node(s) 700.

In some embodiments, a computer program including instructions which, when executed by at least one processor, causes the at least one processor to carry out the functionality of the network node 600 or a node (e.g., a processing node 700) implementing one or more of the functions 710 of the network node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

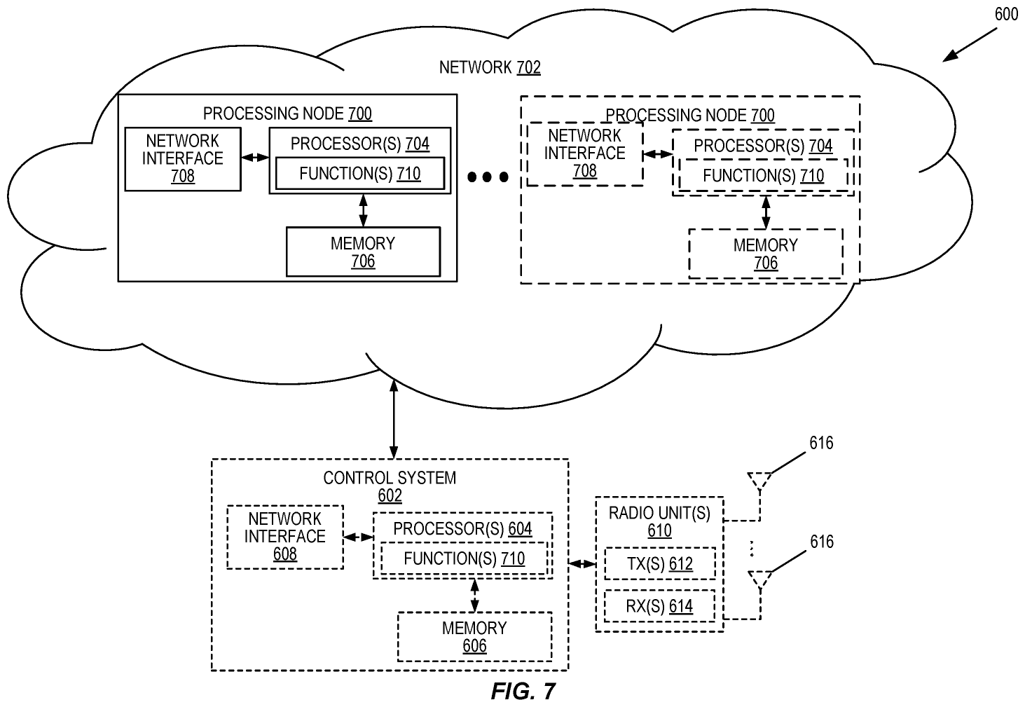

FIG. 8 is a schematic block diagram of the network node 600 according to some other embodiments of the present disclosure. The network node 600 includes one or more modules 800, each of which is implemented in software. The module(s) 800 provide the functionality of the network node 600 described herein (e.g., one or more functions of the RAN node 202, NG-RAN node 202, or AMF 300, as described herein). This discussion is equally applicable to the processing node 700 of FIG. 7 where the modules 800 may be implemented at one of the processing nodes 700 or distributed across multiple processing nodes 700 and/or distributed across the processing node(s) 700 and the control system 602.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1-3. (canceled)

4. A method performed by a network node for a cellular communications system, the method comprising:
receiving a Radio Resource Control, RRC, message from a User Equipment, UE, comprising an unknown cause value; and
sending a message to a core network node, the message comprising an indication that the unknown cause value is included in the RRC message received from the UE.

5. The method of claim 4 wherein the message sent to the core network node is a NGAP message.

6. The method of claim 4 wherein the RRC message is an RRC message for establishment of an RRC connection.

7. The method of claim 6 wherein the unknown cause value is comprised in an EstablishmentCause Information Element, IE, comprised in the RRC message for establishment of the RRC connection.

8. The method of claim 6 wherein the unknown cause value is comprised in an EstablishmentCause-NB Information Element, IE, comprised in the RRC message for establishment of the RRC connection.

9. The method of claim 4 wherein the RRC message is an RRC message for resuming an RRC connection.

10. The method of claim 9 wherein the unknown cause value is comprised in a ResumeCause Information Element, IE, comprised in the RRC message for resuming the RRC connection.

11. The method of claim 4 wherein the message sent to the core network node is a NGAP message, and the indication that the unknown cause value is included in the RRC message received from the UE is an existing notAvailable code point in a NGAP RRC Establishment Cause IE comprised in the NGAP message.

12. The method of claim 4 wherein the message sent to the core network node is a NGAP message, and the indication that the unknown cause value is included in the RRC message received from the UE is a new code point in a NGAP RRC Establishment Cause IE comprised in the NGAP message.

13. The method of claim 4 wherein the message sent to the core network node is a NGAP message, and the NGAP message is an NGAP Initial UE Message.

14. The method of claim 4 wherein the network node is a Next Generation RAN, NG-RAN, node.

15. The method of claim 4 wherein the core network node is an Access and Mobility Management Function, AMF.

16. (canceled)

17. (canceled)

18. A network node comprising processing circuitry configured to cause the network node to:
receive a Radio Resource Control, RRC, message from a User Equipment, UE, comprising an unknown cause value; and
send a message to a core network node, the message comprising an indication that the unknown cause value is included in the RRC message received from the UE.

19. A method performed by a core network node for a cellular communications system, comprising:
receiving a message from a Radio Access Network, RAN, node in a RAN of the cellular communications system, the message comprising an indication that an unknown cause value is included in a Radio Resource Control, RRC, message received by the RAN node from a User Equipment, UE.

20-33. (canceled)

34. A core network node for a cellular communications system, the core network node comprising processing circuitry configured to cause the core network node to:
receive a message from a Radio Access Network, RAN, node in a RAN of the cellular communications system, the message comprising an indication that an unknown cause value is included in a Radio Resource Control, RRC, message received by the RAN node from a User Equipment, UE.

35. A method performed in a cellular communications system, the method comprising:
at a Radio Access Network, RAN, node in a RAN of the cellular communications system:
receiving a Radio Resource Control, RRC, message from a User Equipment, UE, comprising an establishment cause value that is known to the RAN node but is unknown to a core network node to which a message is to be sent; and
sending a message to the core network node, the message comprising an indication that the establishment cause value included in the RRC message received from the UE is an establishment cause value that is unknown to the core network node; and
at the core network node in a core network of the cellular communications system:
receiving the message from the RAN node.

36. The method of claim 35 wherein the establishment cause value included in the RRC message received from the UE does not have an explicitly defined mapping to a cause value for the message to be sent to the core network node.

37. The method of claim 35 wherein the indication is an existing codepoint.

38. The method of claim 37 wherein the existing codepoint is a “not available” value.

39. The method of claim 35 wherein the indication is a new codepoint for the cause value included in the message sent to the core network node.
